(19) United States
(12) Patent Application Publication
(10) Pub. No.: US 2015/0078977 A1
(43) Pub. Date: Mar. 19, 2015

(54) AMINE SCRUBBING SOLUTION FOR ABSORPTION OF CARBON DIOXIDE, WITH OXIDATION INHIBITORS

(71) Applicant: Siemens Aktiengesellschaft, Munich (DE)

(72) Inventors: Bjorn Fischer, Frankfurt a.M (DE); Ralph Joh, Seligenstadt (DE); Diego Andres Kuettel, Kassel (DE); Rudiger Schneider, Eppstein (DE)

(73) Assignee: Siemens Aktiengesellschaft, Munich (DE)

(21) Appl. No.: 14/394,092

(22) PCT Filed: Mar. 21, 2013
(86) PCT No.: PCT/EP2013/055967

§ 371 Date: Oct. 12, 2014

(30) Foreign Application Priority Data
Apr. 17, 2012 (EP) 12164433.0

(51) Int. Cl. B01D 53/14; B01D 53/62

(52) U.S. Cl. CPC B01D 53/1493; B01D 53/62; B01D 53/1475; B01D 2258/0283; B01D 2252/606; B01D 2252/20494; B01D 2252/20478
USPC 423/228; 252/190

(57) ABSTRACT

A method is provided for separating carbon dioxide from a flue gas of an incineration system, wherein bicin and/or EDTA is mixed as an oxidation inhibitor into a scrubbing solution with an amine-containing absorption agent, the flue gas is brought into contact with the scrubbing solution prepared in such a manner for absorption of the carbon dioxide contained therein, and the scrubbing solution is then thermally treated, the carbon dioxide being desorbed thereby. A corresponding scrubbing solution comprising an amine-containing absorption agent and comprising bicin and/or EDTA as an oxidation inhibitor is also provided.

### CROSS REFERENCE TO RELATED APPLICATIONS

This application is the US National Stage of International Application No. PCT/EP2013/055967 filed Mar. 21, 2013, and claims the benefit thereof. The International Application claims the benefit of European Application No. EP12164433 filed Apr. 17, 2012. All of the applications are incorporated by reference herein in their entirety.

### FIELD OF INVENTION

The invention relates to a scrubbing solution for absorbing carbon dioxide from a flue gas of a combustion plant. The invention relates further to a method for separating carbon dioxide from a flue gas of a combustion plant by means of a scrubbing solution of this kind.

### BACKGROUND OF INVENTION

In the combustion of a fossil fuel in a combustion plant, such as, for example, in a fossil-fired power station for producing electrical energy, the flue gas which forms carries a not inconsiderable load of carbon dioxide. Besides carbon dioxide, a flue gas of this kind contains other combustion products, such as the gases nitrogen, sulfur oxides, nitrogen oxides, and water vapor, for example, and also particulate solids, dusts, and soot. Following extensive separation of the solid constituents, the flue gas is commonly discharged to the atmosphere. Where appropriate, nitrogen oxides and/or sulfur oxides are separated off as well, by catalytic or wet-chemical means. As a natural constituent of the Earth's atmosphere, however, carbon dioxide is normally included in the discharge to the atmosphere.

The human-caused increase in the fraction of carbon dioxide in the Earth's atmosphere, however, is held responsible as a major cause of the rise in the Earth's surface temperatures, referred to as climate change. The reason is that carbon dioxide present in the atmosphere hinders the radiative loss of heat from the Earth's surface into space, known generally as the greenhouse effect.

Accordingly, in the context of existing power plants, appropriate secondary measures are being discussed for removing the carbon dioxide arising after combustion from the flue gas. As one technical possibility, this is accomplished by contacting the flue gas with a scrubbing solution, to which a suitable absorbent for carbon dioxide has been added. Appearing presently the most promising are amine-containing absorbents, with amines used being alkanolamines in particular, but also more complex sterically hindered amines with large alkyl groups, cyclic amines, amino acids, or amino acid salts. Either the amines used form carbamates with carbon dioxide, or the carbon dioxide undergoes indirect reaction in the scrubbing solution to form hydrogencarbonate and a protonated amine.

As a result of the contact of the flue gas with the scrubbing solution, gaseous carbon dioxide included is dissolved in the scrubbing solution and/or absorbed in a chemical sense. The flue gas freed from carbon dioxide is discharged into the atmosphere. The scrubbing solution laden with carbon dioxide can be conveyed to a different location, where it is regenerated again by a heat treatment with desorption of the carbon dioxide. The carbon dioxide separated can then, for example, be subjected to multistage compression, cooling, and liquefaction. In the liquid or frozen state, the carbon dioxide can be subsequently passed on to storage or commercial utilization. The regenerated scrubbing solution is used again to absorb carbon dioxide from the flue gas.

In the case of an amine-containing scrubbing solution, the relatively high oxygen content of a flue gas may result in unwanted oxidative degradation. This may be accompanied by formation of degradation products, only some of which can be reformed in the desorption process. Such degradation products lead to a lowering of the capacity of the scrubbing solution to take up carbon dioxide. Furthermore, the degradation products may promote corrosion, and alter the flow properties of the scrubbing solution. There may also be a change in the pH of the scrubbing solution, which has a substantial influence over the absorption capacity of the amine-containing scrubbing solution.

In spite of their inherently very good stability toward oxygen, amino acid salts also tend toward a certain oxygen degradation. In this case, depending on the particular amino acid salt employed, the degradation products may include some which are highly volatile, such as ammonia, methylamine, or formaldehyde, for example. Such volatile components lead to an additional unwanted burden on the environment. In the atmosphere, further products may be formed.

Aside from the undesirable consequences listed of degradation products of the amines employed, especially oxidative degradation products, degradation also leads always to a loss of absorbent employed. The absorbent must therefore be added continuously to the process, thereby having the deleterious effect of raising the operating costs of the separation process.

### SUMMARY OF INVENTION

It is an object of the invention, therefore, to specify a scrubbing solution of the type stated at the outset, and also a method for separating carbon dioxide from the flue gas of a combustion plant, whereby an improvement in economy over the prior art is possible.

With regard to the scrubbing solution for absorbing carbon dioxide from a flue gas of a combustion plant, the object is achieved in accordance with the invention by the addition to the scrubbing solution, as well as an amine-containing absorbent, of ethylenediaminetetraacetate (in short: EDTA) and/or N,N-bis(2-hydroxyethyl)glycine (in short: bicine) as an oxidation inhibitor. As well as an amine-containing absorbent, therefore, the scrubbing solution employed additionally comprises EDTA and/or bicine.

The basis for the invention is the consideration that metal ions incorporated into the scrubbing solution by the flue gas are a cause of the oxidative degradation of the amines and especially of the amino acid salts. Nickel ions and copper ions, in particular, exhibit comparatively high catalytic activity for oxidative degradation of amino acid salts. Even very small amounts in the region of several mmol (1/1000 mol) of Cu²⁺ and Ni²⁺ ions already greatly affect the oxidative degradation process. Iron ions, especially Fe^{2±}/Fe³⁺ ions, have the unwanted effect in turn of catalyzing the oxidative degradation of alkanolamines very effectively. The catalytic activity with regard to degradation of amino acid salts is present, but fairly small.

If EDTA is introduced additionally into the scrubbing solution, it is able, as a complexing agent, to bind the metal ions, considered presently to be a cause of the oxidative degradation, and thereby to hinder or retard the degradation of the amines employed. Through formation of complexes with copper ions and nickel ions, however, bicine as well has proven an effective inhibitor for the oxidative degradation of the amines.

The invention, accordingly, envisages deliberately admixing EDTA and/or bicine to a scrubbing solution with an amine-containing absorbent. Through the addition of EDTA and/or bicine, the oxidative degradation of the amines employed or of the amine-containing absorbent employed can be actively inhibited. The reason for this is the “scavenging” caused by formation of a complex, of the metal ions which are catalytic for the oxidation and which are introduced into the scrubbing solution via the flue gas.

In one advantageous embodiment of the scrubbing solution, it comprises a mixture of EDTA and bicine as oxidation inhibitor. It has in fact emerged that a mixture of EDTA and bicine displays a greater inhibition of the oxidative degradation than the individual substances on their own in each case.

In one advantageous variant, the fraction of bicine and EDTA corresponds in total at least to the fraction of the catalyzing metal ions in the scrubbing solution. The fraction of bicine and EDTA in total is advantageously at least 1 mMol (1/1000 Mol) and up to 100 mMol. Within the stated concentration ranges, there is an economically relevant inhibition of the oxidative degradation. The absorption capacity of the scrubbing solution is not significantly adversely affected by the addition of EDTA and/or bicine.

The scrubbing solution advantageously takes the form of an aqueous solution. The use of water has become established by virtue of the position of its boiling point, and also from environmental considerations, and not least for reasons of cost.

The amine-containing scrubbing composition may fundamentally comprise a single amine or a mixture of amines. Amines used may be primary amines, such as monoethanolamine or diglycolamine, secondary amines, such as diethanolamine or diisopropanolamine, and tertiary amines such as methyldiethanolamines. Complex amines, such as sterically hindered amines for formation of carbamate, or cyclic amines, may also be used. In the case of a sterically hindered amine, formation of carbamate is hindered, for example, by a large alkyl group on the amino group, as is the case, for example, for a 2-amino-2-methyl-1-propanol. A cyclic amine is, for example, a piperazine and its derivatives. In turn, a single amino acid salt, such as a potassium salt of glycine, for example, or other amino acids, may be used. Mixtures of different amino acid salts may also be employed as absorbents.

In the context of an amino acid salt, it has emerged as being advantageous if an amino acid salt is employed which has a carbon substituent from the group containing hydrogen, an alkyl, a hydroxyalkyl, and an amino alkyl. In further aspects, an amino acid salt is employed which has a nitrogen substituent from the group containing hydrogen, an alkyl, a hydroxyalkyl, and a haloalkyl.

In a further advantageous embodiment, the amino acid salt is a salt of a metal, more particularly of an alkali metal.

An object, with regard to a method for separating carbon dioxide from a flue gas of a combustion plant, is achieved in accordance with the invention by admixing bicine and/or EDTA as oxidation inhibitor to a scrubbing solution with an amine-containing absorbent, where the flue gas is subsequently contacted with the thus-processed scrubbing solution, with absorption of included carbon dioxide, and the scrubbing solution is subsequently heat-treated, with desorption of the carbon dioxide.

Advantageously, the above-described scrubbing solution is used for the method, and/or a scrubbing solution of this kind is processed. The advantages stated in the dependent claims to the scrubbing solution may be sensibly transposed here to the method for separating carbon dioxide.

### BRIEF DESCRIPTION OF THE DRAWINGS

Exemplary embodiments of the invention are elucidated in more detail with a drawing. In the drawing:

FIG. 1 shows, in a schematic representation, a separating device for carbon dioxide from the flue gas of a combustion plant,

FIG. 2 shows a structural formula with general validity for an amino acid salt,

FIG. 3 shows a diagram with a number of measurement plots relating to the temporal profile of an oxygen partial pressure over a scrubbing solution,

FIG. 4 shows a structural formula of EDTA, and

FIG. 5 shows a structural formula of bicine.

### DETAILED DESCRIPTION OF INVENTION

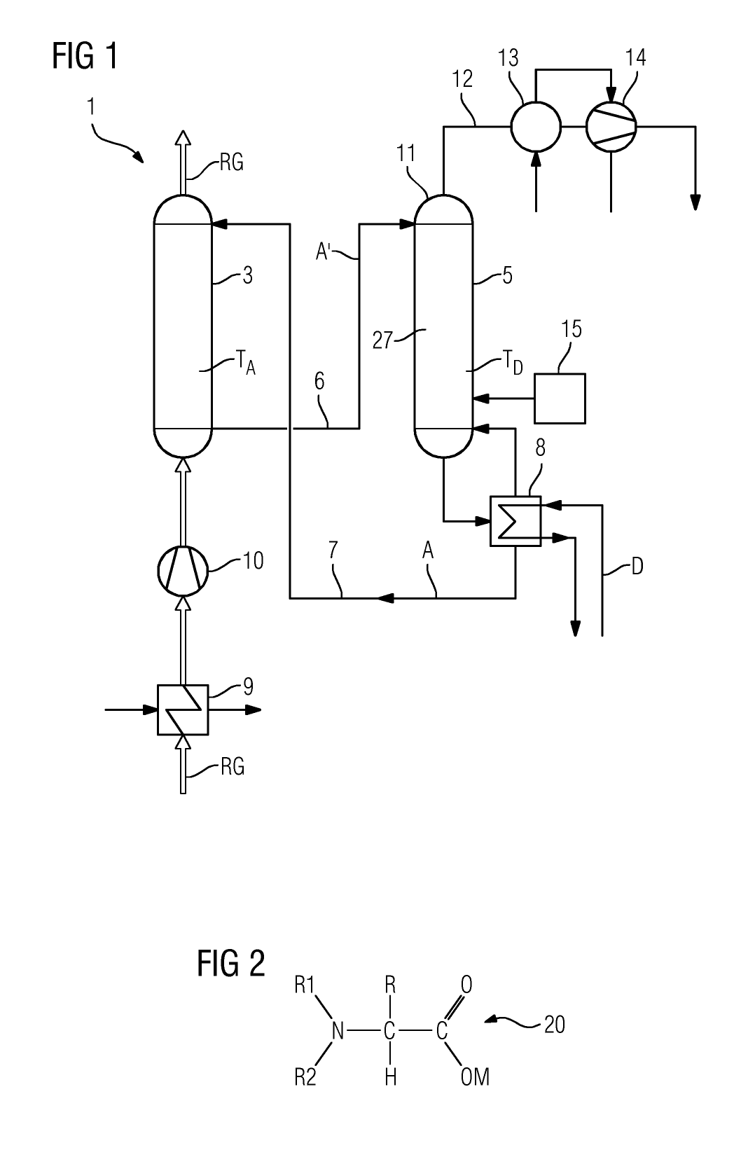

FIG. 1 shows a schematic representation of a separating device 1 for separating carbon dioxide from a flue gas of a combustion plant. The separating device 1 comprises an absorption means 3 and also a desorption means 5, circulating between which, in lines 6, 7, are a laden scrubbing solution A′ and a regenerated scrubbing solution A, respectively. Via the line 6, a scrubbing solution A′ laden with carbon dioxide is passed from the absorption means 3 into the desorption means 5 for regeneration. Via the line 7, regenerated scrubbing solution A from the desorption means 5 is conveyed back into the absorption means 3.

The desorption means 5 is assigned a reboiler 8, through which, in the operational case, a process steam D is passed to a combustion plant, for the supply of heat. This heat is introduced into the desorption means 5 via recirculation of the scrubbing solution A, and so scrubbing solution A present therein is heated to a desorption temperature T_{D}, causing thermal desorption of dissolved carbon dioxide.

For the separation of carbon dioxide, in the operational case, the flue gas RG of the combustion plant is first cooled in a flue gas cooler 9 and then passed via a conveying means 10 to the absorption means 3. There, the cool flue gas RG is contacted in countercurrent with regenerated scrubbing solution A, and so carbon dioxide included is absorbed and/or dissolved. At an absorption temperature T_{A}, the amine-containing scrubbing solution A has a high loading capacity for carbon dioxide. The flue gas RG freed from carbon dioxide is discharged into the atmosphere.

The scrubbing solution A′ laden with carbon dioxide flows for regeneration into the desorption means 5. In the top region of the desorption means 5, carbon dioxide-rich gas is diverted via a gas line 12 and guided via a heat exchanger 13 and also via a downstream compressor 14. Entrained gaseous carbon dioxide is compressed in the compressor 14 and used for further purposes, being injected, for example, into an aquifer, or carried into another form of carbon dioxide store.

The separating device 1 shown is especially suitable for use in a steam power station, in a gas turbine plant, or in a combined gas and steam turbine plant, especially with integrated gasification of coal, for the separation of carbon dioxide from the flue gas. The separating device 1 is especially appropriate for modernizing or retrofitting of a power plant of this kind.

The scrubbing solution A employed comprises an amine or a mixture of two or more amines. The scrubbing solution advantageously comprises an amino acid salt or plurality of amino acid salts. Additionally the scrubbing solution is admixed with bicine or EDTA, more particularly a mixture of EDTA and bicine, as oxidation inhibitor. In this way, oxidative degradation of amines, especially of the amino acid salts employed, is effectively hindered or prevented. This reduces the demand for absorbent, thereby lowering the operating costs for the separating device 1 overall. Since oxidative degradation is prevented, there are also, consequently, no volatile degradation products produced that would escape, undesirably, into the atmosphere. Nor does preventing the formation of such degradation products adversely affect the absorption capacity of the scrubbing solution.

FIG. 2 shows the general structural formula of an amino acid salt 20, which according to one embodiment is used as absorbent in the scrubbing solution A of the separating device 1. The scrubbing solution A is added in this case as an aqueous solution.

The amino acid salt 20 has a carbon substituent R and further nitrogen substituents R1 and R2. The carbon substituent R is a compound from the group of hydrogen, alkyl, hydroxyalkyl, and aminoalkyl. The further nitrogen constituents R1 and R2 are taken from the group of hydrogen, alkyl, hydroxyalkyl, and haloalkyl. The amino acid salt 20 is a salt of a metal M, more particularly a salt of an alkali metal, potassium or sodium for example, with a proton in the carboxyl group having been replaced by the metal M in ionic form.

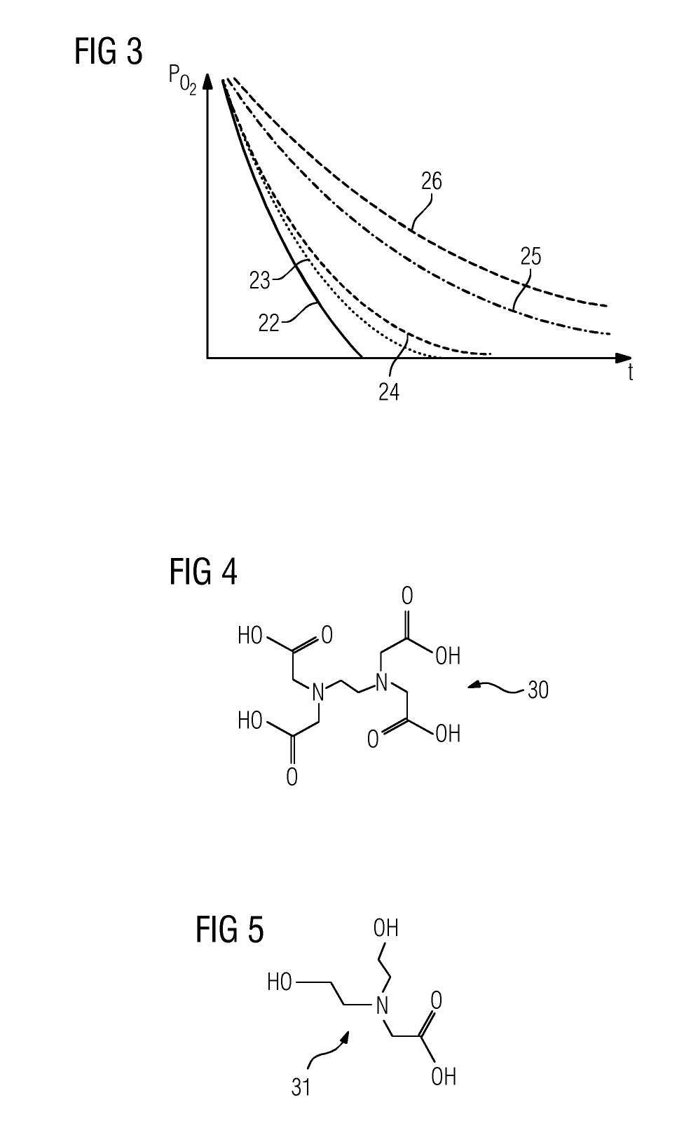

FIG. 3 shows a diagram with a plurality of measurement plots 22 to 26. The individual measurement plots 22 to 26 correspond to the profile of the oxygen partial pressure P_{O2} over time t. Here, in a closed-off system, the temporal decrease of an initially set oxygen partial pressure P_{O2} over different scrubbing solutions is observed. This decrease is a measure of the oxygen consumption in the scrubbing solution, i.e., for oxygen degradation of the absorbents present.

In all of the experiments, the scrubbing solution used in each case was an aqueous solution with an amino acid salt, in the present case sarcosine (N-methylglycine), with a concentration of 4 mol. Additionally, copper ions and nickel ions with a concentration of 1 mmol were added.

The measurement plot 22 shows the temporal profile of the oxygen partial pressure P_{O2} over the scrubbing solution thus prepared. The measurement plot 23 shows the profile of the oxygen partial pressure P_{O2} over a scrubbing solution to which additionally bicine has been added as oxidation inhibitor, with a concentration of 1 mmol. The measurement curve 24 corresponds to the case of a scrubbing solution to which EDTA in a concentration of 1 mmol has been additionally added as oxidation inhibitor. The measurement plot 25 reflects the experiment in which the scrubbing solution was admixed as oxidation inhibitor with a mixture of EDTA and bicine, with a concentration of 5 mmol in each case. The measurement plot 26 corresponds, finally, to the profile over a pure scrubbing solution to which no metal ions have been added.

It is apparent that through addition of metal ions, the oxygen consumption of the scrubbing solution under analysis rises greatly. The metal ions catalyze the oxidative degradation of the amino acid salt used. Measurement plots 22 and 26 differ greatly from one another.

Adding bicine (plot 23) or EDTA (plot 25) already visibly lowers the oxidative degradation of the amino acid salts. By addition of a mixture of EDTA and bicine, the profile of the oxygen partial pressure approaches virtually the profile over a scrubbing solution without metal ions. Consequently, the oxidative degradation of the amino acid salts is very effectively suppressed by a mixture of EDTA and bicine.

FIGS. 4 and 5 show the structural formulae for EDTA 30 and for bicine 31, respectively.

1.-12. (canceled)

13. A scrubbing solution for absorbing carbon dioxide from a flue gas of a combustion plant, comprising
at least one amine-containing absorbent, the amine comprising an amino acid salt, and
a mixture of EDTA and bicine as an oxidation inhibitor.

14. The scrubbing solution as claimed in claim 13,
wherein the fraction of bicine and EDTA in total being at least 1 mmol/L and up to 100 mmol/L.

15. The scrubbing solution as claimed in claim 13,
wherein the scrubbing solution is in the form of an aqueous solution.

16. The scrubbing solution as claimed in claim 13,
further comprising a plurality of amines.

17. The scrubbing solution as claimed in claim 13,
further comprising as amine an alkanolamine and/or a sterically hindered amine to form carbamate.

18. The scrubbing solution as claimed in claim 13,
wherein the amino acid salt comprises a carbon substituent from the group containing hydrogen, an alkyl, a hydroxyalkyl, and an aminoalkyl.

19. The scrubbing solution as claimed in claim 13,
wherein the amino acid salt comprises a nitrogen substituent from the group containing hydrogen, an alkyl, a hydroxyalkyl, and a haloalkyl.

20. The scrubbing solution as claimed in claim 13,
wherein the amino acid salt comprises a salt of a metal.

21. A method for separating carbon dioxide from a flue gas of a combustion plant, the method comprising:
a scrubbing solution with an amine-containing absorbent comprising an amino acid salt as amine is admixed with a mixture of bicine and EDTA as oxidation inhibitor,
the flue gas is contacted with the thus-processed scrubbing solution, with absorption of included carbon dioxide, and
subsequently the scrubbing solution is heat-treated, with desorption of the carbon dioxide.

22. The method as claimed in claim 21,
wherein processing takes place of a scrubbing solution in accordance with claim 13.

23. The scrubbing solution as claimed in claim 20,
wherein the metal comprises an alkali metal.
